(19) United States
(12) Patent Application Publication
(10) Pub. No.: US 2007/0182506 A1
(43) Pub. Date: Aug. 9, 2007

(54) Splitter circuit including transistors

(75) Inventor: Akihisa Iikura, Fukushima-ken (JP)

Correspondence Address: BEYER WEAVER LLP, P.O. BOX 70250, OAKLAND, CA, 94612-0250, US

(73) Assignee: ALPS ELECTRIC CO., LTD.

(21) Appl. No.: 11/654,885

(22) Filed: Jan. 17, 2007

(30) Foreign Application Priority Data
Feb. 3, 2006 (JP) 2006-026776

(51) Int. Cl. H01P 5/12

(52) U.S. Cl. 333/100

(57) ABSTRACT

A splitter circuit includes a plurality of transistors each including a collector that is connected to a direct-current power supply and a base to which a common input signal is supplied, and a plurality of first resistors each including one end that is grounded and the other end that is connected to an emitter of a corresponding one of the plurality of transistors. A signal that appears on the emitter of each of the plurality of transistors is output from the other end of a corresponding one of the plurality of first resistors as an output signal.

### BACKGROUND OF THE INVENTION

1. Field of the Invention

The present invention relates to a splitter circuit that can be used to distribute signals.

2. Description of the Related Art

A type of known splitter circuit that is used to distribute radio frequency (RF) signals is a surface-mountable Y-shaped distribution circuit (the Wilkinson circuit) that uses microstrip lines (see Japanese Unexamined Patent Application Publication No. 5-199022).

FIG. 7 shows the structure of a typical splitter circuit disclosed in Japanese Unexamined Patent Application Publication No. 5-199022.

In a splitter circuit 101 shown in FIG. 7, a first terminal P1, a second terminal P2, and a third terminal P3 that input and output signals are provided on side faces 123 of a board 102, and transmission lines 105 and 106 that include microstrip lines are provided between the first terminal P1 and the second terminal P2 and between the first terminal P1 and the third terminal P3, respectively, on a board surface 121. Input signals are distributed or combined between the first terminal P1 and the second terminal P2 and the third terminal P3 to be output.

In the known splitter circuit, since signals are distributed through patterns (transmission lines) provided on the surface of the board, the patterns for distributing signals require a large area. Thus, it is difficult to implement the known splitter circuit in the form of an integrated circuit.

### SUMMARY OF THE INVENTION

In view of the aforementioned problem, it is an object of the present invention to provide a splitter circuit that can be readily implemented in the form of an integrated circuit and requires a reduced packaging area.

A splitter circuit according to the present invention includes a plurality of transistors each including a collector that is connected to a direct-current power supply and a base to which a common input signal is supplied, and a plurality of first resistors each including one end that is grounded and the other end that is connected to an emitter of a corresponding one of the plurality of transistors. A signal that appears on the emitter of each of the plurality of transistors is output from the other end of a corresponding one of the plurality of first resistors as an output signal.

In the splitter circuit, the plurality of transistors constitute a multi-state emitter-follower circuit, and the common input signal supplied to the base of each of the plurality of transistors is distributed as many output signals as the number of states handled by the emitter-follower circuit. Thus, the splitter circuit can be readily implemented in the form of an integrated circuit, and the packaging area can be significantly reduced.

The splitter circuit may further include a plurality of second resistors each including one end that is connected to the other end of a corresponding one of the plurality of first resistors and the other end from which the output signals is output.

Thus, the output impedance can be increased by the added second resistors, and a stable operation can be achieved in a high-frequency range.

The splitter circuit may further include a plurality of third resistors that are connected in series to individual portions between the emitters of the plurality of transistors and the other ends of the plurality of first resistors corresponding to the plurality of transistors.

Thus, the output impedance can be increased by the added third resistors, and a stable operation can be achieved in a high-frequency range. It is preferable that at least the plurality of transistors and the plurality of first resistors be integrated on an integrated circuit.

In the present invention, a splitter circuit that can be readily implemented in the form of an integrated circuit and requires a reduced packaging area can be provided.

The present invention can be applied to a splitter circuit that can distribute RF signals.

### BRIEF DESCRIPTION OF THE DRAWINGS

FIG. 1 is a block diagram of a splitter circuit according to a first embodiment of the present invention;

FIG. 2 is a chart showing the characteristics of the splitter circuit shown in FIG. 1;

FIG. 3 is a block diagram of a splitter circuit according to a second embodiment of the present invention;

FIG. 4 is a chart showing the characteristics of the splitter circuit shown in FIG. 3;

FIG. 5 is a block diagram of a splitter circuit according to a third embodiment of the present invention;

FIG. 6 is a chart showing the characteristics of the splitter circuit shown in FIG. 5; and

FIG. 7 is a block diagram of a known surface-mountable splitter circuit.

### DESCRIPTION OF THE PREFERRED EMBODIMENTS

Splitter circuits according to embodiments of the present invention will now be described in detail with reference to the attached drawings.

### First Embodiment

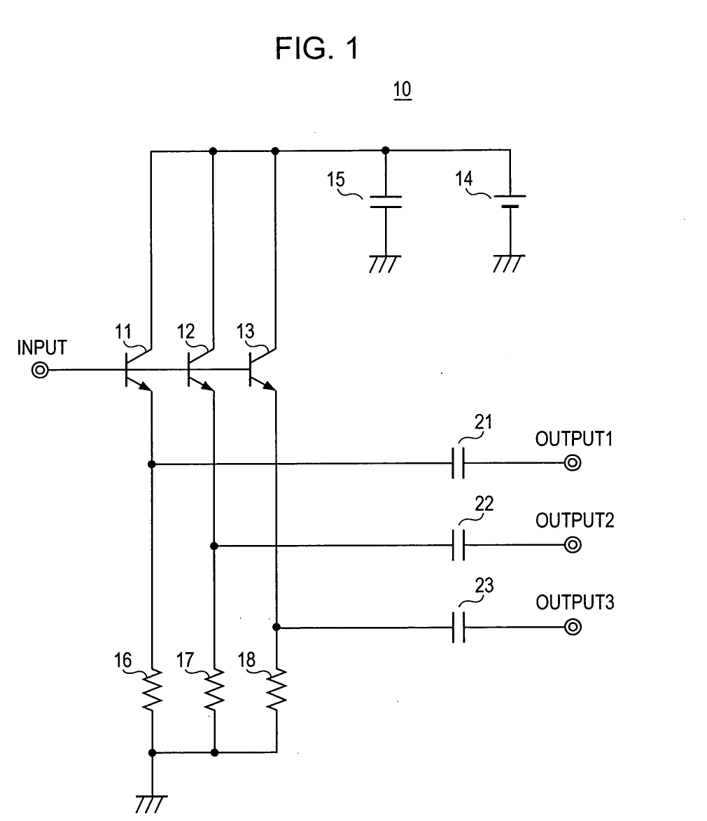

FIG. 1 is a block diagram of a splitter circuit according to a first embodiment. A splitter circuit 10 includes three bipolar transistors 11, 12, and 13. Individual collectors of the bipolar transistors 11, 12, and 13 are connected to the positive electrode of a direct-current power supply 14 and one end of a bypass capacitor 15 the other end of which is grounded. The bypass capacitor 15 grounds the collectors of the bipolar transistors 11, 12, and 13 for high frequencies.

On the other hand, individual emitters of the bipolar transistors 11, 12, and 13 are grounded via resistors 16, 17, and 18 that are first resistors, respectively. The amount of the current passing through each of the emitters is adjusted depending on the resistance value of each of the resistors 16, 17, and 18. Individual intermediate connection points between the individual emitters of the bipolar transistors 11, 12, and 13 and the corresponding resistors 16, 17, and 18 are connected to three output terminals OUTPUT1, OUTPUT2, and OUTPUT3 of the splitter circuit 10 via direct-current blocking capacitors 21, 22, and 23, respectively.

Individual bases of the bipolar transistors 11, 12, and 13 are connected to connected to an input terminal INPUT of the splitter circuit 10. In this arrangement, a common input signal is supplied to the individual bases of the bipolar transistors 11, 12, and 13.

In the first embodiment, the bipolar transistors 11, 12, and 13 and the resistors 16, 17, and 18 are provided on one chip in the form of an integrated circuit. The chip may further include the bypass capacitor 15 and the direct-current blocking capacitors 21, 22, and 23.

In the splitter circuit 10 having the aforementioned structure, a three-state emitter-follower circuit is formed, in which an input signal supplied to the input terminal INPUT is distributed to be output from the output terminals OUTPUT1, OUTPUT2, and OUTPUT3.

For example, when a high-frequency signal of 860 MHz is supplied to the input terminal INPUT, the high-frequency signal is applied to the bases of the bipolar transistors 11, 12, and 13. On the other hand, the collectors of the bipolar transistors 11, 12, and 13 are grounded by the bypass capacitor 15 for high frequencies, and a direct-current voltage Vcc from the direct-current power supply 14 is applied to the collectors. Thus, signals (high-frequency signals) corresponding to the high-frequency signal applied to the bases of the bipolar transistors 11, 12, and 13 appear on the emitters of the bipolar transistors 11, 12, and 13 and are output from the output terminals OUTPUT1, OUTPUT2, and OUTPUT3 via the direct-current blocking capacitors 21, 22, and 23.

In this way, an input signal supplied to the input terminal INPUT of the splitter circuit 10 can be distributed via the three-state emitter-follower circuit, which includes the bipolar transistors 11, 12, and 13, into three signals to be output from the output terminals OUTPUT1, OUTPUT2, and OUTPUT3 of the splitter circuit 10.

The result of simulation of the impedance characteristics of the splitter circuit 10 shows that the splitter circuit 10 can reliably perform a signal distribution operation without oscillation within a wide range of about 50 MHz to 2 GHz.

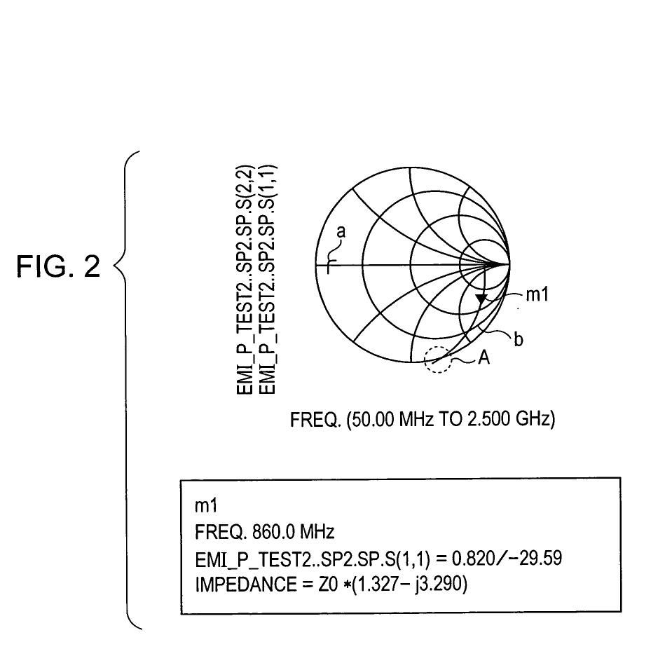

FIG. 2 shows the result of simulation of the input and output impedance characteristics of the splitter circuit 10. In FIG. 2, a change in the output impedance (a) and a change in the input impedance (b) in a range of 50 MHz to 2.5 GHz are plotted on a Smith chart. For example, a point m1 indicates the input impedance at 860 MHz. An appropriate input impedance is ensured at 860 MHz. This shows that the operation of the splitter circuit 10 is stable.

In the first embodiment, since a multi-state emitter-follower circuit is provided to distribute signals, an integrated circuit can be readily implemented. Thus, a significant reduction in an area where the splitter circuit 10 is provided can be achieved. Furthermore, since an area where the splitter circuit 10 is provided is significantly reduced, the number of emitter-follower circuits can be increased to increase the number of signals to be distributed.

### Second Embodiment

In a splitter circuit according to a second embodiment, the output impedance is increased by adding resistors on emitter sides of the bipolar transistors 11, 12, and 13.

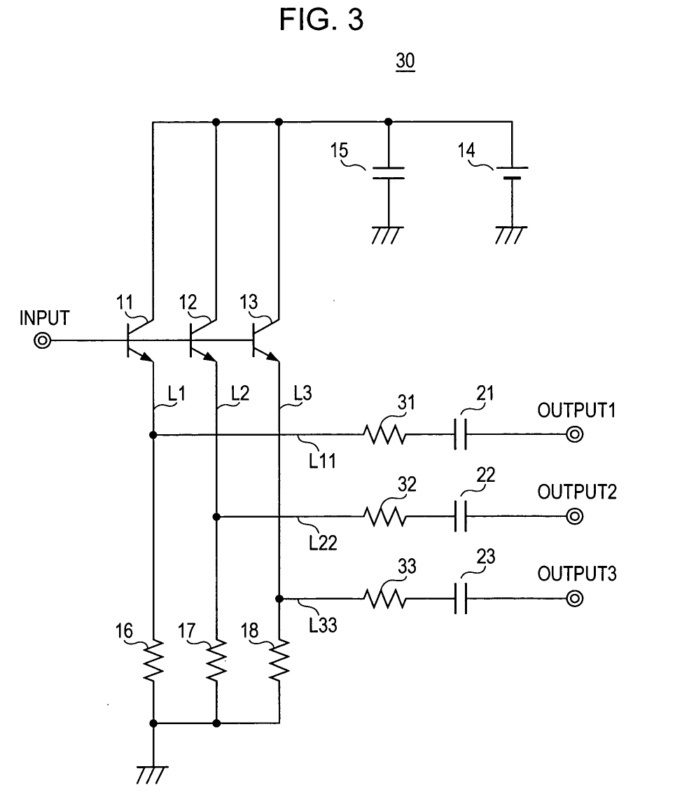

FIG. 3 is a block diagram of the splitter circuit according to the second embodiment. The same reference numerals and letters as in the first embodiment are assigned to corresponding components. In a splitter circuit 30 according to the second embodiment, an intermediate point of a signal line L1 that connects the emitter of the bipolar transistor 11 to the resistor 16 is connected to the output terminal OUTPUT1 via a signal line L11, and a resistor 31 that is one of the second resistors is connected in series to a point on the signal line L11 between the intermediate point of the signal line L1 and the direct-current blocking capacitor 21. Moreover, an intermediate point of a signal line L2 that connects the emitter of the bipolar transistor 12 to the resistor 17 is connected to the output terminal OUTPUT2 via a signal line L22, and a resistor 32 that is one of the second resistors is connected in series to a point on the signal line L22 between the intermediate point of the signal line L2 and the direct-current blocking capacitor 22. Moreover, an intermediate point of a signal line L3 that connects the emitter of the bipolar transistor 13 to the resistor 18 is connected to the output terminal OUTPUT3 via a signal line L33, and a resistor 33 that is one of the second resistors is connected in series to a point on the signal line L33 between the intermediate point of the signal line L3 and the direct-current blocking capacitor 23.

The other components in the second embodiment are the same as those in the first embodiment. That is to say, the bases of the bipolar transistors 11, 12, and 13 are connected to the input terminal INPUT, and the collectors are connected to the positive electrode of the direct-current power supply 14 and the one end of the bypass capacitor 15, the other end of which is grounded. Moreover, the emitters of the bipolar transistors 11, 12, and 13 are grounded via the corresponding resistors 16, 17, and 18, respectively.

In the splitter circuit 30 having the aforementioned structure, an input signal supplied to the input terminal INPUT of the splitter circuit 30 can be distributed via the three-state emitter-follower circuit, which includes the bipolar transistors 11, 12, and 13, into three signals to be output from the output terminals OUTPUT1, OUTPUT2, and OUTPUT3 of the splitter circuit 30.

In the second embodiment, in the three-state emitter-follower circuit, the resistors 31 to 33 are provided on three paths for distributed signals. Thus, the output impedance in the second embodiment is large compared with that in the first embodiment.

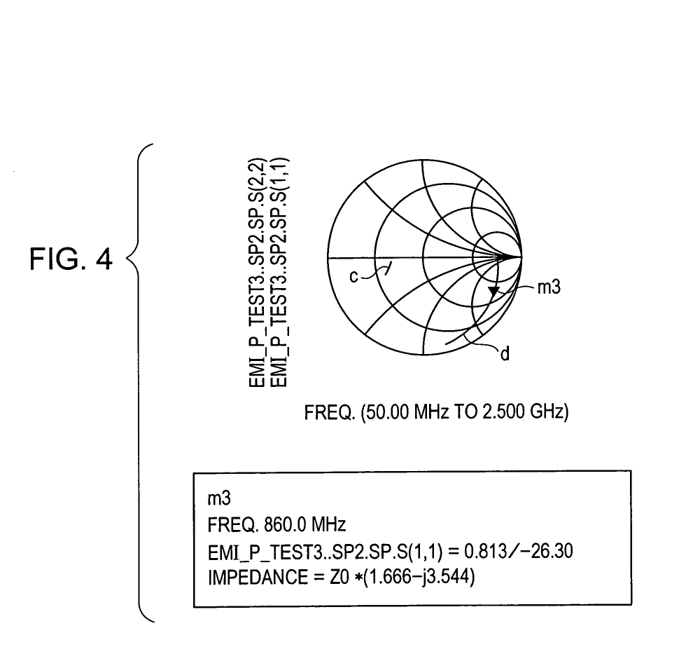

FIG. 4 shows the result of simulation of the input and output impedance characteristics of the splitter circuit 30 under the same conditions of the current as in the simulation shown in FIG. 2. In FIG. 4, a change in the output impedance (c) and a change in the input impedance (d) in a range of 50 MHz to 2.5 GHz are plotted on a Smith chart. Comparing FIG. 4 with FIG. 2 shows that the output impedance (c) is relatively large in the second embodiment. Moreover, since the output impedance (c) becomes large, the input impedance (d) is improved, so the input impedance (d) falls within the base circle of the Smith chart even in a range of high frequencies exceeding 2 GHz.

When the input impedance (b) in a range of high frequencies exceeding 2 GHz deviates from the base circle, as in an area A indicated by a dotted circle in FIG. 2, the operation may be unstable in the high-frequency range, and oscillation may occur. In contrast, when the input impedance falls within the base circle, as shown in FIG. 4, the operation is stable.

Moreover, a point m3 shown in FIG. 4 indicates the input impedance at 860 MHz. An appropriate input impedance is ensured at 860 MHz. This shows that the operation of the splitter circuit 30 is stable.

In the second embodiment, the resistors 31 to 33 are connected in series to individual points on the signal lines L11, L22, and L33 extending from the signal lines L1 to L3 connecting the emitters of the bipolar transistors 11, 12, and 13 to the resistors 16, 17, and 18 to the corresponding output terminals OUTPUT1, OUTPUT2, and OUTPUT3. Thus, the output impedance (c) is large, and a stable operation can be achieved in a wide range of 50 MHz to 2.5 GHz.

### Third Embodiment

In a splitter circuit according to a third embodiment, the output impedance is increased by adding resistors on emitter sides of the bipolar transistors 11, 12, and 13.

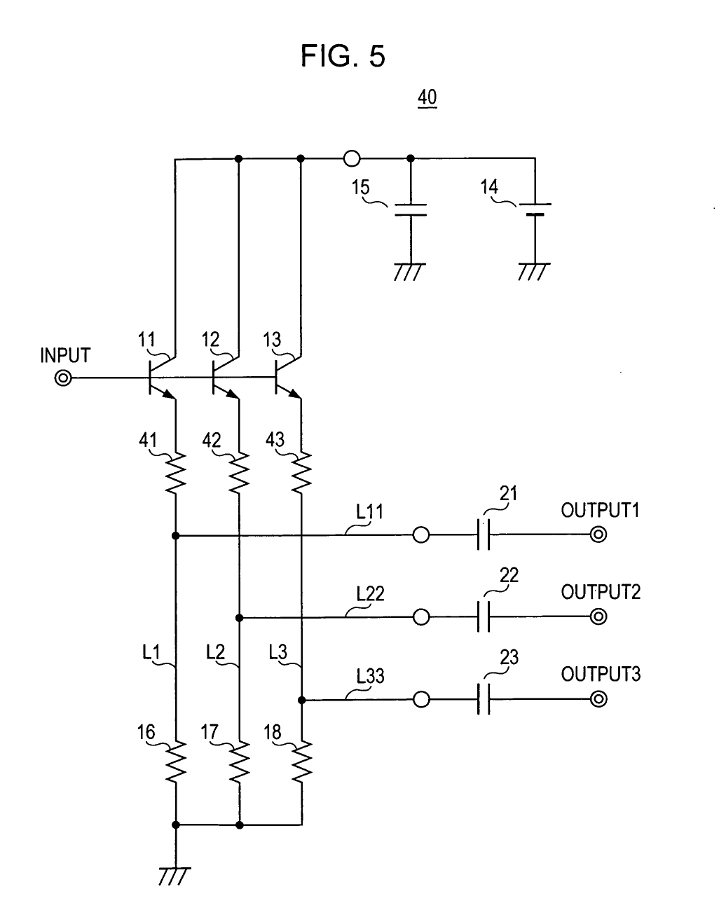

FIG. 5 is a block diagram of the splitter circuit according to the third embodiment. The same reference numerals and letters as in the first and second embodiments are assigned to corresponding components. In a splitter circuit 40 according to the third embodiment, an intermediate point of the signal line L1 connecting the emitter of the bipolar transistor 11 to the resistor 16 is connected to the output terminal OUTPUT1 via the signal line L11, and a resistor 41 that is one of the third resistors is connected in series to a point on the signal line L1 between the intermediate point of the signal line L1 and the emitter of the bipolar transistor 11. Moreover, an intermediate point of the signal line L2 connecting the emitter of the bipolar transistor 12 to the resistor 17 is connected to the output terminal OUTPUT2 via the signal line L22, and a resistor 42 that is one of the third resistors is connected in series to a point on the signal line L2 between the intermediate point of the signal line L2 and the emitter of the bipolar transistor 12. Moreover, an intermediate point of the signal line L3 connecting the emitter of the bipolar transistor 13 to the resistor 18 is connected to the output terminal OUTPUT3 via the signal line L33, and a resistor 43 that is one of the third resistors is connected in series to a point on the signal line L3 between the intermediate point of the signal line L3 and the emitter of the bipolar transistor 13.

The other components in the third embodiment are the same as those in the first embodiment. That is to say, the bases of the bipolar transistors 11, 12, and 13 are connected to the input terminal INPUT, and the collectors are connected to the positive electrode of the direct-current power supply 14 and the one end of the bypass capacitor 15, the other end of which is grounded. Moreover, the emitters of the bipolar transistors 11, 12, and 13 are grounded via the corresponding resistors 16, 17, and 18, respectively.

In the splitter circuit 40 having the aforementioned structure, an input signal supplied to the input terminal INPUT of the splitter circuit 40 can be distributed via the three-state emitter-follower circuit, which includes the bipolar transistors 11, 12, and 13, into three signals to be output from the output terminals OUTPUT1, OUTPUT2, and OUTPUT3 of the splitter circuit 40.

In the third embodiment, in the three-state emitter-follower circuit, the resistors 41 to 43 are provided on three paths for distributed signals. Thus, the output impedance in the third embodiment is large compared with that in the first embodiment.

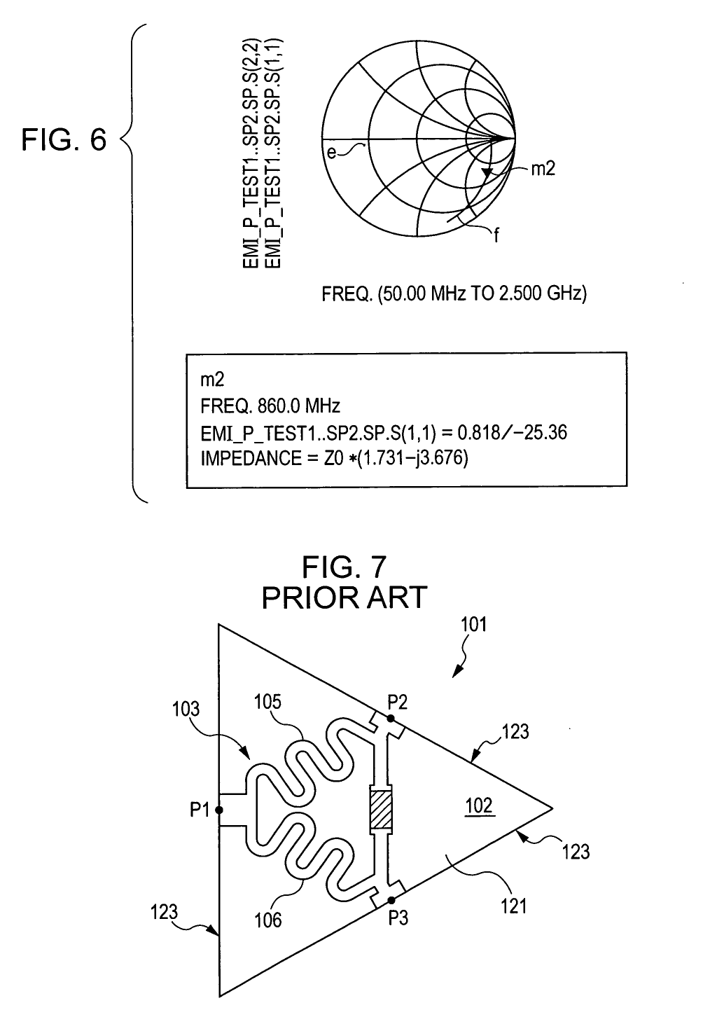

FIG. 6 shows the result of simulation of the input and output impedance characteristics of the splitter circuit 40 under the same conditions of the current as in the simulation shown in FIG. 2. In FIG. 6, a change in the output impedance (e) and a change in the input impedance (f) in a range of 50 MHz to 2.5 GHz are plotted on a Smith chart. Comparing FIG. 6 with FIG. 2 shows that the output impedance (e) is relatively large in the third embodiment. Moreover, since the output impedance (e) becomes large, the input impedance (f) is improved, so the input impedance (f) falls within the base circle of the Smith chart even in a range of high frequencies exceeding 2 GHz.

Moreover, a point m2 shown in FIG. 6 indicates the input impedance at 860 MHz. An appropriate input impedance is ensured at 860 MHz. This shows that the operation of the splitter circuit 40 is stable.

In the third embodiment, the resistors 41 to 43, which are the third resistors, are connected in series to points between the emitters of the bipolar transistors 11, 12, and 13 and the resistors 16, 17, and 18, which are the first resistors, and output signals are output from ends of the resistors 16, 17, and 18 on the sides of the emitters. Thus, the output impedance (e) is large, and a stable operation can be achieved in a wide range of 50 MHz to 2.5 GHz.

The present invention is not limited to the first to third embodiments. In the first to third embodiments, the emitter-follower circuit is a three-state emitter-follower circuit. Alternatively, for example, a two state or four or more state emitter-follower circuit may be used. Moreover, an integrated circuit may be implemented using metal oxide semiconductor (MOS) transistors instead of the bipolar transistors.

What is claimed is:

1. A splitter circuit comprising:
a plurality of transistors each including a collector that is connected to a direct-current power supply and a base to which a common input signal is supplied; and
a plurality of first resistors each including one end that is grounded and the other end that is connected to an emitter of a corresponding one of the plurality of transistors, wherein
a signal that appears on the emitter of each of the plurality of transistors is output from the other end of a corresponding one of the plurality of first resistors as an output signal.

2. The splitter circuit according to claim 1, further comprising:
a plurality of second resistors each including one end that is connected to the other end of a corresponding one of the plurality of first resistors and the other end from which the output signals is output.

3. The splitter circuit according to claim 1, further comprising:
a plurality of third resistors that are connected in series to individual portions between the emitters of the plurality of transistors and the other ends of the plurality of first resistors corresponding to the plurality of transistors.

4. The splitter circuit according to claim 1, wherein at least the plurality of transistors and the plurality of first resistors are integrated on an integrated circuit.
